(19) United States
(12) Patent Application Publication
(10) Pub. No.: US 2021/0321652 A1
(43) Pub. Date: Oct. 21, 2021

(54) COOKED RICE PRODUCING METHOD, LIQUID SEASONING, AND METHOD FOR SUPPRESSING OCCURRENCE OF UNDERCOOKED PORTION FORMATIONS IN COOKED RICE

(71) Applicant: Wakou Shokuhin Co., Ltd., Otaru-shi (JP)

(72) Inventor: Masaaki KITAGAWA, Otaru-shi (JP)

(73) Assignee: Wakou Shokuhin Co., Ltd., Otaru-shi (JP)

(21) Appl. No.: 17/186,138

(22) Filed: Feb. 26, 2021

(30) Foreign Application Priority Data
Apr. 17, 2020 (JP) 2020-073962

(51) Int. Cl. A23L 7/196; A23L 5/10; A23L 27/00; A23L 27/30; C12J 1/08

(52) U.S. Cl. CPC A23L 7/1965; A23L 5/13; A23L 27/82; A23V 2002/00; A23L 27/36; A23L 27/37; C12J 1/08; A23L 27/32

(57) ABSTRACT

A cooked rice producing method is configured to include carrying out rice boiling after adding a liquid seasoning which has a solid content of saccharides of from 0 to 32% by mass, a degree of sweet taste of from 30 to 85, and an acetic acid conversion acidity of from 2.5 to 5.7. Cooked rice, produced by carrying out rice boiling after adding a liquid seasoning, includes a solid content of saccharides of from 0 to 32% by mass, a degree of sweet taste of from 30 to 85, and an acetic acid conversion acidity of from 2.5 to 5.7. A liquid seasoning includes a solid content of saccharides of from 0 to 32% by mass, a degree of sweet taste of from 30 to 85, and an acetic acid conversion acidity of from 2.5 to 5.7, to be used by being added before rice boiling. A method for suppressing the occurrence of undercooked portion formations in cooked rice, includes carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.

### CROSS-REFERENCE TO RELATED APPLICATION

The present application is based on Japanese patent application No.2020-073962 filed on Apr. 17, 2020, the entire contents of which are incorporated herein by reference.

### BACKGROUND OF THE INVENTION

### 1. FIELD OF THE INVENTION

The present invention relates to a cooked rice producing method, a liquid seasoning, and a method for suppressing the occurrence of undercooked portion formations in cooked rice.

### 2. DESCRIPTION OF THE RELATED ART

Conventionally, when a flavoring ingredient such as a sushi vinegar or the like is mixed with cooked rice, mixing the flavoring ingredient in a powdered state or a liquid state with the cooked rice while stirring the rice cooked by boiling is being carried out. However, there have been a problem with the shape and texture of the cooked rice being affected by a rice grain crushing being caused by the stirring of the cooked rice during the mixing, and a problem with the mixing becoming uneven with an increase in the scale of production such as production for industrial use or the like.

In order to improve these problems, a method has been known that carries out rice boiling by adding the flavoring ingredient such as a sushi vinegar or the like before the rice boiling, but there have been a problem with no desired flavor being produced by loss of a sour taste and a sweet taste to be inherently imparted by the rice boiling, and a problem with the occurrence of undercooked portion formations in the cooked rice arising from the rice boiling with the addition of the flavoring ingredient.

In view of the foregoing, as methods for carrying out the rice boiling with a sushi vinegar being added before the rice boiling, in order to suppress the occurrence of a vinegar volatilization, there have thus far been reported a sushi rice producing method (JP2016-0342442A) using a fermented vinegar with a specific amount of calcium oxide being dissolved therein, and a sushi rice producing method (JPS54-023143A) by adding a dietary oil-and/or-fat such as butter. Although the sour taste has been able to be expected to be improved to some extent by the above methods, there has still been room for consideration on imparting a flavor equivalent to that of the conventional sushi rice to the cooked rice, and on suppressing the occurrence of undercooked portion formations in the cooked rice.

[Patent Document 1] JP2016-0342442A

[Patent Document 2] JPS54-023143A

### SUMMARY OF THE INVENTION

In light of the above problems, it is an object of the present invention to provide a cooked rice producing method, which is able to impart to cooked rice a flavor equivalent to those of the conventional rice cooked by boiling and subsequent giving of a taste, and to suppress the occurrence of undercooked portion formations in the cooked rice, a liquid seasoning, which is configured to be used in the aforementioned method, and a method for suppressing the occurrence of undercooked portion formations in the cooked rice. The present inventor has completed the present invention by finding out that the above problems can be solved by carrying out rice boiling after adding a liquid seasoning in which a solid content of saccharides is not higher than a specific amount, and in which a sweet taste and an acetic acid conversion acidity fall within respective specific ranges. That is, specifically, the present invention provides aspects as specified in (1) to (6) below.

(1) A cooked rice producing method, comprising carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.

(2) The cooked rice producing method as defined in (1) above, wherein the liquid seasoning includes at least one of a dietary vinegar and a high-intensity sweetener.

(3) The cooked rice producing method as defined in (2) above, wherein the high-intensity sweetener comprises one or two or more selected from the group consisting of neotame, stevia, sucralose, aspartame, and glycyrrhizin.

(4) Cooked rice, produced by carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.

(5) A liquid seasoning, comprising a solid content of saccharides of from 0 to 32% by mass, a degree of sweet taste of from 30 to 85, and an acetic acid conversion acidity of from 2.5 to 5.7, to be used by being added before rice boiling.

(6) A method for suppressing the occurrence of undercooked portion formations in cooked rice, comprising carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.

(Points of the Invention)

The present invention eliminates the need for mixing a liquid flavoring to give a taste after the rice boiling, which is particularly advantageous when the scale of production is large, such as production for industrial use or the like. In addition, it is possible to provide the cooked rice that are as excellent in a sour taste and a sweet taste as the conventional cooked rice with the flavoring ingredient being mixed therein after the rice boiling, and that are reduced in the occurrence of undercooked portion formations. Furthermore, the cooked rice produced by the production method according to the present invention can also be expected to have the advantageous effect of maintaining their sour taste and sweet taste for a long period of time, and having a stable flavor, and have the potential to contribute to food loss as well.

### DETAILED DESCRIPTION OF THE PREFERRED EMBODIMENTS

Although a specific embodiment of the present invention will be described in detail below, the present invention is not in any way limited to the following embodiment, but the present invention can be carried out by making appropriate alternations within the scope of the object of the present invention.

[Method for Producing Cooked Rice]

The cooked rice producing method according to the present invention is characterized by carrying out rice boiling after adding a liquid seasoning (hereinafter, also referred to as “the liquid seasoning according to the present invention”) which comprises a solid content of saccharides of from 0 to 32% by mass, a degree of sweet taste of from 30 to 85, and an acetic acid conversion acidity of from 2.5 to 5.7. As a result, the cooked rice according to the present invention is produced by being boiled, together with the same liquid seasoning. Here, in the present invention, the “rice boiling” refers to heating rice by combining methods of boiling, steaming, and baking, to thereby produce cooked rice such as boiled rice and the like. Further, in the present invention, the “rice” refers to rice, glutinous rice, brown rice and the like.

For the cooked rice producing method according to the present invention, the liquid seasoning according to the present invention may be added before carrying out the rice boiling, and for the rice boiling itself, it is possible to employ a method that is typically being used.

The cooked rice producing method according to the present invention is a method configured to produce the cooked rice, for example, by adding, to washed rice, water of from 1.1 to 1.5 times (preferably from 1.2 to 1.3 times) the volume of the rice before being washed, followed by soaking of the washed rice in the added water for 20 to 60 minutes, or followed by no soaking, and subsequent addition of the liquid seasoning according to the present invention of from 0.1 to 0.4 times (preferably from 0.1 to 0.3 times) the volume of the rice before being washed, to evenly dissolve and disperse that added liquid seasoning according to the present invention in the added water, followed by holding and boiling the rice in a rice cooker at from 100 to 120 degrees C. for from 20 to 80 minutes (preferably from 40 to 60 minutes). Here, for the aforementioned rice cooker, it is possible to use a rice cooker for home use or for industrial use. Further, the cooked rice producing method according to the present invention may be configured in such a manner as to add the liquid seasoning according to the present invention in the step of soaking the rice in the water.

As will be described later, the cooked rice producing method according to the present invention is able to suppress the occurrence of undercooked portion formations in the cooked rice even when the step of soaking the cooked rice in the water is excluded therefrom. The cooked rice in the present invention is not particularly limited, but is preferably sushi rice. Here, the sushi rice refers to a cooked rice to be used in nigiri sushi (hand pressed sushi), chirashi sushi (scattered sushi), hand rolled sushi, bowl of rice topped with sashimi, and the like.

[Seasoning Liquid]

The liquid seasoning according to the present invention is a liquid seasoning, which is present in a liquid state at an ambient temperature (of from 1 to 30 degrees C.), and comprises a solid content of saccharides of from 0 to 32% by mass, a degree of sweet taste of from 30 to 85, and an acetic acid conversion acidity of from 2.5 to 5.7, to be used by being added before rice boiling.

Note that the liquid seasoning according to the present invention can also conceptually include a powdered or solid aggregate of flavoring ingredients (one including saccharides, a high-intensity sweetener, a dietary vinegar, and the like) preliminarily formulated to serve as a liquid seasoning being present in a liquid state to meet the conditions as mentioned above.

[Saccharides]

The saccharides to be used in the present invention are not particularly limited, but examples of the saccharides include sugar, sucrose, isomerized liquid sugar syrup, fructose, glucose, maltose, starch syrup, honey and the like, invert sugar, lactose, syrup, oligosaccharide, sugar alcohols, and the like, and a mixture of these. Here, the sugar includes non-centrifugal sugar such as brown sugar lump and the like, and centrifugal sugar such as white superior soft sugar, soft brown sugar and the like; the isomerized liquid sugar syrup includes high fructose liquid sugar syrup, fructose glucose liquid sugar syrup, and glucose fructose liquid sugar syrup; and the sugar alcohols include sorbitol, lactitol, reduced palatinose, mannitol, reduced starch glycated product (reduced starch syrup), and the like. For the saccharides to be used in the present invention, the sugar and the reduced starch glycated product (reduced starch syrup) are preferable, and the sugar is especially preferable. The liquid seasoning according to the present invention has a solid content of the saccharides of preferably from 2 to 30% by mass, more preferably from 5 to 25% by mass, and most preferably from 10 to 20% by mass. When the solid content of the saccharides contained in the liquid seasoning according to the present invention falls within the above ranges, the advantageous effect of suppressing the occurrence of undercooked portion formations in the cooked rice and the advantageous effect of imparting a sweet taste to the cooked rice are more easily achieved. Further, when the liquid seasoning according to the present invention is configured to contain both the saccharides present in a liquid state and the saccharides present in a solid state, the liquid seasoning according to the present invention may be configured in such a manner that the total of the amount contained as the solid content of the saccharides present in a liquid state and the amount of the contained saccharides present in a solid state is adjusted to be a desired contained amount within the above ranges.

Note that when the saccharides are present in a liquid state, the solid content thereof can be obtained by a loss on drying method (105 degrees C., 4 hours).

An especially preferable aspect of the liquid seasoning according to the present invention is as follows: The liquid seasoning according to the present invention contains the sugar in an amount of preferably from 2 to 30% by mass, more preferably from 5 to 25% by mass, and most preferably from 10 to 20% by mass. When the sugar content of the liquid seasoning according to the present invention falls within the above ranges, the advantageous effect of maintaining the sweet taste of the cooked rice for a long period of time is more easily achieved.

[Degree of Sweet Taste]

The degree of sweet taste in the present invention is an index indicating the intensity of the sweet taste, and is expressed in terms of relative values when the intensity of the sweet taste (at 20 degrees C.) of 1% by mass of sucrose is set at 1. The degrees of sweet taste of sweet taste ingredients of each type can be obtained from a known sugar sweet taste conversion table or the like. For example, the degree of sweet taste of neotame is 10000, the degree of sweet taste of stevia is 200, the degree of sweet taste of sucralose is 600, the degree of sweet taste of aspartame is 200, the degree of sweet taste of glycyrrhizin is 50, and the degree of sweet taste of reduced starch syrup is 0.3. Note that, in the present invention, the sweet taste ingredients refer to saccharides and high-intensity sweeteners.

The liquid seasoning according to the present invention ranges preferably from 35 to 80, more preferably from 40 to 70, and most preferably from 50 to 60 in the aforementioned degree of sweet taste. When the degree of sweet taste of the liquid seasoning according to the present invention falls within the above ranges, the advantageous effect of imparting a sweet taste equivalent to those of the conventional rice cooked by boiling and subsequent giving of a taste is more easily achieved.

[High-Intensity Sweetener]

The liquid seasoning according to the present invention is configured to preferably contain a high-intensity sweetener. Here, in the present invention, the high-intensity sweetener refers to a synthetic sweetener, or a natural sweetener, which is not lower than 30 in the degree of sweet taste. Specific examples of the above high-intensity sweeteners include aspartame, stevia, sucralose, glycyrrhizin, phyllodulcin, luo han guo (monk fruit), thaumatin, monellin, saccharin, acesulfame potassium, neotame, alitame, advantame, sodium cyclamate, and the like. Further, for the high-intensity sweetener to be used in the present invention, it is also possible to use a formulation triturated or diluted with an excipient or the like.

The high-intensity sweetener according to the present invention comprises preferably one or two or more selected from the group consisting of neotame, stevia, sucralose, aspartame, and glycyrrhizin, more preferably one or two or more selected from the group consisting of neotame, stevia, and sucralose, and most preferably a combination of neotame and stevia, or a combination of neotame and sucralose.

When the liquid seasoning according to the present invention consists only of the high-intensity sweeteners, the liquid seasoning according to the present invention may be configured in such a manner that the amount of the contained high-intensity sweeteners is adjusted by converting the respective amounts of the contained high-intensity sweeteners to respective equivalent amounts of sucrose on the basis of the individual degrees of sweet taste, so that the degree of sweet taste resulting from adding up the respective degrees of sweet taste of those sugar substitutes is the aforementioned desired degree of sweet taste of the liquid seasoning according to the present invention. Further, when the liquid seasoning according to the present invention is configured to contain the saccharides and the high-intensity sweeteners, the liquid seasoning according to the present invention may be configured in such a manner that the amounts of the contained saccharides and the contained high-intensity sweeteners are adjusted so that the degree of sweet taste resulting from adding up the degrees of sweet taste derived from the saccharides and the degrees of sweet taste derived from the high-intensity sweeteners calculated as described above is the aforementioned desired degree of sweet taste of the liquid seasoning according to the present invention. Furthermore, when the liquid seasoning according to the present invention is configured to contain the saccharides and the high-intensity sweeteners, it is preferable that the amount of the contained high-intensity sweeteners is adjusted so as to account for preferably from 50 to 85%, more preferably from 60 to 80%, and most preferably 70 to 75% of the overall degree of sweet taste of the liquid seasoning according to the present invention.

Note that when the liquid seasoning according to the present invention is a liquid seasoning containing an oil phase and an aqueous phase, it may be configured in such a manner as to contain the saccharides and/or the high-intensity sweeteners so that the degree of sweet taste in the aqueous phase is the aforementioned desired degree of sweet taste of the liquid seasoning according to the present invention.

[Acetic Acid Conversion Acidity]

The acetic acid conversion acidity in the present invention is the acidity (%) obtained by converting all the acids contained in the liquid seasoning according to the present invention into acetic acid. The acetic acid conversion acidity can be obtained by the following method.

Exactly 25 ml of a sample of the liquid seasoning according to the present invention is taken and is diluted 10 times with water. The 25 ml diluted sample is taken, and is fed into a flask, followed by addition of 2 drops of phenol phthalein as an indicator, and subsequent titration with a 0.1N-sodium hydroxide solution having a known titer. The acetic acid conversion acidity is calculated by using the following formula.

Acetic acid conversion acidity (%)=0.006×V×F×(overall diluted solution amount (250 ml))/(taken diluted sample amount (25 ml))×(1/taken sample amount (25 ml))×100

V: Average titrated amount (ml) of 0.1N—NaOH standard solution

F: Titer of 0.1N—NaOH standard solution

The liquid seasoning according to the present invention ranges preferably from 3.0 to 5.5, more preferably from 3.5 to 4.5, and most preferably from 3.7 to 4.3 in the acetic acid conversion acidity. When the acetic acid conversion acidity of the liquid seasoning according to the present invention falls within the above ranges, the advantageous effect of imparting a sour taste equivalent to those of the conventional rice cooked by boiling and subsequent giving of a taste is more easily achieved.

[Dietary Vinegar]

The liquid seasoning according to the present invention is configured to preferably contain a dietary vinegar. The dietary vinegar is not particularly limited, but examples thereof include fermented vinegar (grain vinegar, fruit vinegar), synthetic vinegar and the like.

When the liquid seasoning according to the present invention is configured to contain the dietary vinegar, the liquid seasoning according to the present invention may be configured in such a manner that the amount of the contained dietary vinegar is adjusted so that the acetic acid conversion acidity derived from the dietary vinegar is the aforementioned desired acetic acid conversion acidity of the liquid seasoning according to the present invention. Further, when the liquid seasoning according to the present invention is a liquid seasoning containing an oil phase and an aqueous phase, it may be configured in such a manner as to contain the dietary vinegar so that the acetic acid conversion acidity in the aqueous phase is the aforementioned desired acetic acid conversion acidity of the liquid seasoning according to the present invention.

[Other Raw Materials]

The liquid seasoning according to the present invention may contain other raw materials as long as the advantageous effects of the present invention are not hindered. Examples of the raw materials include “umami” taste seasonings (monosodium glutamate, sodium inosinate, protein hydrolyzate, yeast extract, kelp extract, bonito extract, and the like), dietary salt, mirin, soy sauce, spices, pH adjusters, thickening polysaccharides, emulsifiers, oils and fats, and the like. Herein, the “extract” or “umami taste extract” includes “yeast extract”, “kelp extract”, “bonito extract”, and the like.

Further, for the liquid seasoning according to the present invention, it is preferable that the liquid seasoning is colored with kelp extract or the like so that it can be visually identified that the same seasoning is evenly spreading throughout the cooked rice.

The liquid seasoning according to the present invention may contain dietary salt. p The amount of the dietary salt to be contained in the liquid seasoning according to the present invention ranges preferably from 5 to 15% by mass, more preferably from 6 to 12% by mass, and most preferably from 7 to 9% by mass.

The liquid seasoning according to the present invention may contain water. The amount of the water to be contained in the liquid seasoning according to the present invention ranges preferably from 5 to 45% by mass, more preferably from 10 to 35% by mass, and most preferably from 20 to 30% by mass.

The liquid seasoning according to the present invention may be free of calcium oxide and isomalt. The liquid seasoning according to the present invention may be free of calcium oxide. The liquid seasoning according to the present invention may be free of isomalt.

Preferably, the liquid seasoning consists of dietary vinegar, sugar, dietary salt, high-intensity sweetener, umami taste seasoning, and water. More preferably, the liquid seasoning consists of dietary vinegar, sugar, dietary salt, high-intensity sweetener consisting of at least one of sucralose and neotame, umami taste extract consisting of at least one of kelp extract, yeast extract and bonito extract, and water. Most preferably, the liquid seasoning consists of dietary vinegar, sugar, dietary salt, sucralose, kelp extract, and water.

[Producing Method for the Liquid Seasoning]

The method for producing the liquid seasoning according to the present invention is not particularly limited as long as the producing method renders the same seasoning homogeneous. For example, when the liquid seasoning according to the present invention is configured to contain water, dietary vinegar, sugar, dietary salt, and high-intensity sweeteners, it can be produced by being homogenized by feeding the other raw materials into water and stirring.

[Method for Suppressing the Occurrence of Undercooked Portion Formations in the Cooked Rice]

A method for suppressing the occurrence of undercooked portion formations in the cooked rice according to the present invention is a method configured to, when conducting a cooked rice production, carry out rice boiling after adding a liquid seasoning which has a solid content of the saccharides of from 0 to 32% by mass, a degree of sweet taste of from 30 to 85, and an acetic acid conversion acidity of from 2.5 to 5.7, to thereby allow the undercooked portion formations not to remain in the finished cooked rice. Here, the presence of the undercooked portion formations in the cooked rice refers to a state in which the inside of the rice grains is hard and causes an unpleasant texture sensation when the cooked rice is eaten.

Note that the preferred aspects of the aforementioned cooked rice production, and the aforementioned liquid seasoning are the same as the cooked rice production method according to the present invention, and the liquid seasoning according to the present invention, respectively.

### EXAMPLES

Hereinafter, the present invention will be described more specifically by way of Examples, but the scope of the present invention is not limited to the description of these Examples.

[Production of Sushi Vinegar (the Liquid Seasoning according to the Present Invention)]

According to formulations shown in Tables 1 to 6, respective raw materials were fed into water, stirred and dissolved to produce sushi vinegars of each type. Note that the raw materials used shown in Tables 1 to 6 were as follows.

Dietary vinegar 1: Product name MHV-310, available from Mizkan Co., Ltd., acetic acid conversion acidity 10%

Dietary vinegar 2: Product name MAV, available from Mizkan Co., Ltd., acetic acid conversion acidity 4%

Neotame formulation: Product name Mirasee® 200, available from DSP Gokyo Food & Chemical Co., Ltd., degree of sweet taste 200, neotame content 2% by mass

Stevia: Product name Bertolon 90, available from Tsuruya Chemical Industries, Ltd., degree of sweet taste 200

Sucralose: Product name Sucralose, available from San-Ei Gen F.F.I., Inc., degree of sweet taste 600

Aspartame: Product name PAL SWEET DIET, available from Ajinomoto Healthy Supply Co., Ltd., degree of sweet taste 200

Glycyrrhizin: Product name Glycymin®, available from Maruzen Pharmaceuticals Co., Ltd., degree of sweet taste 50

Reduced starch syrup: Product name SE30, available from DSP Gokyo Food & Chemical Co., Ltd., degree of sweet taste 0.3, solid content 70% by mass

[Production of Sushi Rice (the Cooked Rice according to the Present Invention)]

300 g of unwashed rice, 380 g of water, and 60 g of the sushi vinegar produced as described above were fed into a rice cooker, followed by stirring to render the sushi vinegar and the water homogeneous throughout the rice, and subsequently immediately carrying out rice boiling at 100 degrees C. for 50 minutes to produce sushi rice (in Examples 1 to 17, and comparative examples 1 to 6).

[Evaluation 1 of the Sushi Rice]

The evaluation of the sushi rice was carried out by an evaluation panel of 9 persons, who passed a gustatory test (a sweet taste, umami taste, sour taste, bitter taste, and salty taste identifying test) in accordance with the company's regulations, eating 10 g of the sushi rice produced as described above, scoring those sushi rice on their sour taste and sweet taste in accordance with the following scoring criteria, then calculating the average of those sushi rice' scores given by the 9 persons, and evaluating those sushi rice on the basis of the following evaluation criteria.

In addition, the presence or absence of undercooked portion formations in the rice grains of those sushi rice when eaten was evaluated by the consensus of the evaluation panel of the 9 persons on the basis of the following evaluation criteria. The evaluation results thereof were shown in Tables 1 to 6.

Note that, as a control (control example 1), a sushi rice was used that was produced by evenly blending 80 g of a sushi vinegar of control example 1 in Table 1 into a boiled rice produced by boiling 300 g of unwashed rice and 420 g of water in the same conditions as those described above.

(Sour Taste Evaluation: Scoring Criteria)

7 points: Stronger in sour taste than the control

6 points: Slightly stronger in sour taste than the control

5 points: As strong in sour taste as the control

4 points: Slightly weaker in sour taste than the control

3 points: Weaker in sour taste than the control

(Sour taste evaluation: evaluation criteria)

⊚: 4.60 to 5.40

∘: 4.00 to 4.59, 5.41 to 6.00

×: 3.00 to 3.99, 6.01 to 7.00

(Sweet Taste Evaluation: Scoring Criteria)

7 points: Stronger in sweet taste than the control

6 points: Slightly stronger in sweet taste than the control

5 points: As strong in sweet taste as the control

4 points: Slightly weaker in sweet taste than the control

3 points: Weaker in sweet taste than the control

(Sweet Taste Evaluation: Evaluation Criteria)

⊚: 4.60 to 5.40

∘: 4.00 to 4.59, 5.41 to 6.00

×: 3.00 to 3.99, 6.01 to 7.00

(Evaluation of the Presence or Absence of Undercooked Portion Formations: Evaluation Criteria)

⊚: No undercooked portion formation present, and preferable as the sushi rice

∘: Slightly undercooked portion formations present, but acceptable as the sushi rice

×: Undercooked portion formations present, and not preferable as the sushi rice

The “Degree of sweet taste” in Tables 1 to 6 was obtained from the respective contained amounts and the respective degrees of sweet taste of the raw materials of sugar, reduced starch syrup, and sugar substitutes (neotame, stevia, sucralose, aspartame, glycyrrhizin) having respective high degrees of sweet taste, and by converting them to respective equivalent amounts of sucrose (sugar), and adding up thereof.

The “Acetic acid acidity (%)” in Tables 1 to 6 was the acetic acid conversion acidity (%) in the sushi vinegar calculated from the contained amount and the acetic acid conversion acidity of the dietary vinegar 1 and/or the contained amount and the acetic acid conversion acidity of the dietary vinegar 2, while the “saccharides (% by mass)” were the solid content (% by mass) of the saccharides in the sushi vinegar calculated from the respective contained amounts of the sugar and the reduced starch syrup.

TABLE 1

| | | Control | | | |
|---|---|---|---|---|---|
| | | example 1 | Compar- | Compar- | |
| | | (Add after | ative | ative | |
| | | rice | exam- | exam- | Exam- |
| (% by mass) | | boiling) | ple 1 | ple 2 | ple 1 |
| Dietary vinegar 1 | | | | | 27.00 |
| Dietary vinegar 2 | | 52.00 | 52.00 | 52.00 | 25.00 |
| Sugar | | 37.50 | 37.50 | 15.00 | 15.00 |
| Dietary salt | | 9.00 | 9.00 | 9.00 | 9.00 |
| Neotame formulation | | | | 0.20 | 0.20 |
| Water | | 1.50 | 1.50 | 23.80 | 23.80 |
| Total | | 100.00 | 100.00 | 100.00 | 100.00 |
| Acetic acid acidity (%) | | 2.08 | 2.08 | 2.08 | 3.70 |
| Degree of sweet taste | | 37.5 | 37.5 | 55.0 | 55.0 |
| Saccharides (% by mass) | | 37.5 | 37.5 | 15.0 | 15.0 |
| Evaluation | Sour taste | — | × | × | ⊚ |
| | (Average | | (3.90) | (3.35) | (4.75) |
| | score) | | | | |
| | Sweet taste | — | ⊚ | ⊚ | ⊚ |
| | (Average | | (5.00) | (5.10) | (4.85) |
| | score) | | | | |
| | Undercooked | — | × | ⊚ | ⊚ |
| | portion | | | | |
| | formations | | | | |

TABLE 2

| | | | | | Compar- |
|---|---|---|---|---|---|
| | | Exam- | Exam- | Exam- | ative |
| (% by mass) | | ple 2 | ple 3 | ple 4 | example 3 |
| Dietary vinegar 1 | | 37.00 | 52.00 | 55.00 | 60.00 |
| Dietary vinegar 2 | | 15.00 | | | |
| Sugar | | 15.00 | 15.00 | 15.00 | 15.00 |
| Dietary salt | | 9.00 | 9.00 | 9.00 | 9.00 |
| Neotame formulation | | 0.20 | 0.20 | 0.20 | 0.20 |
| Water | | 23.80 | 23.80 | 20.80 | 15.80 |
| Total | | 100.00 | 100.00 | 100.00 | 100.00 |
| Acetic acid acidity (%) | | 4.30 | 5.20 | 5.50 | 6.00 |
| Degree of sweet taste | | 55.0 | 55.0 | 55.0 | 55.0 |
| Saccharides (% by mass) | | 15.0 | 15.0 | 15.0 | 15.0 |
| Evaluation | Sour taste | ⊚ | ◯ | ◯ | × |
| | (Average | (5.05) | (5.70) | (6.00) | (6.53) |
| | score) | | | | |
| | Sweet taste | ⊚ | ◯ | ◯ | ◯ |
| | (Average | (5.07) | (4.25) | (4.20) | (4 11) |
| | score) | | | | |
| | Undercooked | ⊚ | ⊚ | ⊚ | ⊚ |
| | portion | | | | |
| | formations | | | | |

TABLE 3

| | | | | | Compar- |
|---|---|---|---|---|---|
| | | | | | ative |
| | | Exam- | Exam- | Exam- | exam- |
| (% by mass) | | ple 5 | ple 6 | ple 7 | ple 4 |
| Dietary vinegar 1 | | 37.00 | 37.00 | 37.00 | 37.00 |
| Dietary vinegar 2 | | 15.00 | 15.00 | 15.00 | 15.00 |
| Sugar | | | 5.00 | 30.00 | 35.00 |
| Dietary salt | | 9.00 | 9.00 | 9.00 | 9.00 |
| Neotame formulation | | 0.27 | 0.25 | 0.12 | 0.10 |
| Water | | 38.73 | 33.75 | 8.88 | 3.90 |
| Total | | 100.00 | 100.00 | 100.00 | 100.00 |
| Acetic acid acidity (%) | | 4.30 | 4.30 | 4.30 | 4.30 |
| Degree of sweet taste | | 54.0 | 55.0 | 54.0 | 55.0 |
| Saccharides (% by mass) | | 0.0 | 5.0 | 30.0 | 35.0 |
| Evaluation | Sour taste | ◯ | ◯ | ◯ | ⊚ |
| | (Average | (5.70) | (5.42) | (5.45) | (5.00) |
| | score) | | | | |
| | Sweet taste | ◯ | ⊚ | ⊚ | ⊚ |
| | (Average | (4.48) | (4.85) | (5.00) | (5.18) |
| | score) | | | | |
| | Undercooked | ⊚ | ⊚ | ◯ | × |
| | portion | | | | |
| | formations | | | | |

TABLE 4

| | | Compar- | | | Compar- |
|---|---|---|---|---|---|
| | | ative | | | ative |
| | | exam- | Exam- | Exam- | exam- |
| (% by mass) | | ple 5 | ple 8 | ple 9 | ple 6 |
| Dietary vinegar 1 | | 37.00 | 37.00 | 37.00 | 37.00 |
| Dietary vinegar 2 | | 15.00 | 15.00 | 15.00 | 15.00 |
| Sugar | | 15.00 | 15.00 | 15.00 | 15.00 |
| Dietary salt | | 9.00 | 9.00 | 9.00 | 9.00 |
| Neotame formulation | | 0.05 | 0.10 | 0.25 | 0.40 |
| Water | | 23.95 | 23.90 | 23.75 | 23.60 |
| Total | | 100.00 | 100.00 | 100.00 | 100.00 |
| Acetic acid acidity (%) | | 4.30 | 4.30 | 4.30 | 4.30 |
| Degree of sweet taste | | 25.0 | 35.0 | 65.0 | 95.0 |
| Saccharides | | 15.0 | 15.0 | 15.0 | 15.0 |
| (% by mass) | | | | | |
| Evaluation | Sour taste | ◯ | ◯ | ⊚ | × |
| | (Average | (5.60) | (5.52) | (4.70) | (3.92) |
| | score) | | | | |
| | Sweet taste | × | ◯ | ◯ | × |
| | (Average | (3.90) | (4.30) | (5.97) | (6.72) |
| | score) | | | | |
| | Undercooked | ⊚ | ⊚ | ⊚ | ⊚ |
| | portion | | | | |
| | formations | | | | |

TABLE 5

| | | Exam- | Exam- | Exam- | Exam- |
|---|---|---|---|---|---|
| (% by mass) | | ple 10 | ple 11 | ple 12 | ple 13 |
| Dietary vinegar 1 | | 37.00 | 37.00 | 37.00 | 37.00 |
| Dietary vinegar 2 | | 15.00 | 15.00 | 15.00 | 15.00 |
| Sugar | | 15.00 | 15.00 | 15.00 | 15.00 |
| Dietary salt | | 9.00 | 9.00 | 9.00 | 9.00 |
| Stevia | | 0.20 | | | |
| Sucralose | | | 0.06 | | |
| Aspartame | | | | 0.27 | |
| Glycyrrhizin | | | | | 1.30 |
| Water | | 23.80 | 23.94 | 23.73 | 22.70 |
| Total | | 100.00 | 100.00 | 100.00 | 100.00 |
| Acetic acid acidity (%) | | 4.30 | 4.30 | 4.30 | 4.30 |
| Degree of sweet taste | | 55.0 | 51.0 | 69.0 | 80.0 |
| Saccharides (% by mass) | | 15.0 | 15.0 | 15.0 | 15.0 |
| Evaluation | Sour taste | ⊚ | ⊚ | ⊚ | ⊚ |
| | (Average | (4.74) | (4.72) | (5.20) | (5.20) |
| | score) | | | | |
| | Sweet taste | ◯ | ◯ | ◯ | ◯ |
| | (Average | (5.70) | (5.94) | (4.25) | (4.32) |
| | score) | | | | |
| | Undercooked | ⊚ | ⊚ | ⊚ | ⊚ |
| | portion | | | | |
| | formations | | | | |

TABLE 6

| | | Exam- | Exam- | Exam- | Exam- |
|---|---|---|---|---|---|
| (% by mass) | | ple 14 | ple 15 | ple 16 | ple 17 |
| Dietary vinegar 1 | | 37.00 | 37.00 | 37.00 | 43.00 |
| Dietary vinegar 2 | | 15.00 | 15.00 | 15.00 | |
| Sugar | | 15.00 | 15.00 | 15.00 | 15.00 |
| Reduced starch syrup | | | | | 20.00 |
| Dietary salt | | 9.00 | 9.00 | 9.00 | 9.00 |
| Neotame formulation | | 0.08 | 0.05 | 0.10 | 0.17 |
| Stevia | | | | 0.10 | |
| Sucralose | | 0.04 | | | |
| Aspartame | | | 0.15 | | |
| Water | | 23.88 | 23.80 | 23.80 | 12.83 |
| Total | | 100.00 | 100.00 | 100.00 | 100.00 |
| Acetic acid acidity (%) | | 4.30 | 4.30 | 4.30 | 4.30 |
| Degree of sweet taste | | 55.0 | 55.0 | 55.0 | 55.0 |
| Saccharides (% by mass) | | 15.0 | 15.0 | 15.0 | 29.0 |
| Evaluation | Sour taste | ⊚ | ◯ | ⊚ | ⊚ |
| | (Average | (5.13) | (5.80) | (5.38) | (5.28) |
| | score) | | | | |
| | Sweet taste | ⊚ | ◯ | ⊚ | ⊚ |
| | (Average | (5.05) | (4.10) | (5.28) | (5.39) |
| | score) | | | | |
| | Undercooked | ⊚ | ⊚ | ⊚ | ◯ |
| | portion | | | | |
| | formations | | | | |

From the results in Tables 1 to 6 above, the sushi rice (Examples 1 to 17) produced by carrying out the rice boiling after adding the respective sushi vinegars which had a solid content of the saccharides of from 0 to 32% by mass, a degree of sweet taste of from 30 to 85, and an acetic acid conversion acidity of from 2.5 to 5.7, had their sour taste and sweet taste equivalent to those of the conventional sushi rice (control example 1) produced by boiling and subsequent giving of a taste, and further, were also being reduced in the occurrence of undercooked portion formations in the sushi rice (Examples 1 to 17).

In addition, the above sushi rice (Examples 1 to 17) allowed the omission of the work of mixing the sushi vinegar after the rice boiling, and were therefore able to be produced more conveniently than that produced by the conventional method of producing the sushi rice

(control example 1).

[Evaluation 2 of the Sushi Rice]

For the sushi rice of control example 1 and Example 2 produced as described above, the sour taste and the sweet taste measured after 3 hours at an ambient temperature were evaluated. The evaluation results thereof were shown in Table 7. The evaluation of the sour taste and the sweet taste was carried out in the same manner as in the method described in the “Evaluation 1 of the sushi rice” described above.

TABLE 7

| | | |
|---|---|---|
| | | Control |
| | Exam- | exam- |
| (% by mass) | ple 2 | ple 1 |

| | | | |
|---|---|---|---|
| Evaluation | Sour taste | ⊚ | × |
| | (Average score) | (5.10) | (3.90) |
| | Sweet taste | ◯ | × |
| | (Average score) | (4.10) | (3.80) |

As a result of the evaluation, the sour taste of the sushi rice of control example 1 after 3 hours was “×” and the sweet taste thereof was “×”, so both the sour taste and the sweet taste thereof were weakened, and were not preferable tastes for the sushi rice. On the other hand, the sour taste of the sushi rice of Example 2 after 3 hours was “⊚” and the sweet taste thereof was “◯”, so both the sour taste and the sweet taste thereof were preferable tastes for the sushi rice.

Therefore, it was considered that the sushi rice produced by using the sushi vinegar (the liquid seasoning) according to the present invention was able to maintain a stable flavor for a long period of time after the production.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A cooked rice producing method, comprising:
carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.

2. The cooked rice producing method according to claim 1, wherein the liquid seasoning includes at least one of a dietary vinegar and a high-intensity sweetener.

3. The cooked rice producing method according to claim 2, wherein the high-intensity sweetener comprises one or two or more selected from the group consisting of neotame, stevia, sucralose, aspartame, and glycyrrhizin.

4. Cooked rice, produced by carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.

5. A liquid seasoning, comprising a solid content of saccharides of from 0 to 32% by mass, a degree of sweet taste of from 30 to 85, and an acetic acid conversion acidity of from 2.5 to 5.7, to be used by being added before rice boiling.

6. A method for suppressing the occurrence of undercooked portion formations in cooked rice, comprising carrying out rice boiling after adding a liquid seasoning which comprises a solid content of saccharides of from 0 to 32% by mass, a degree of sweet taste of from 30 to 85, and an acetic acid conversion acidity of from 2.5 to 5.7.
